(19) United States
(12) Patent Application Publication
(10) Pub. No.: US 2013/0085793 A1
(43) Pub. Date: Apr. 4, 2013

(54) METHOD OF PROSECUTING ACQUISITION OF RESPONSES TO A PROPOSITION, AND SYSTEM FOR DOING THE SAME

(71) Applicants: Wayne Evan Cooper, Greenwich, CT (US); Marshall Cooper, Greenwich, CT (US)

(72) Inventors: Wayne Evan Cooper, Greenwich, CT (US); Marshall Cooper, Greenwich, CT (US)

(21) Appl. No.: 13/253,055

(22) Filed: Oct. 4, 2011

(51) Int. Cl. G06Q 10/06

(52) U.S. Cl. 705/7.15; 705/345; 705/342

(57) ABSTRACT

A method, of prosecuting acquisition of formal responses to a formal proposition put forth by a requestor, includes: electronically sending the proposition to a group of recipients; automatically tracking responses to the proposition; automatically determining statistics indicative of the tracked responses including a completion ratio; and electronically presenting to the requestor at least some of the statistics including the completion ratio.

### BACKGROUND

1. Field of the Present invention

The present invention relates to method of prosecuting acquisition of responses to a proposition, and a system for doing the same.

2. Related Art

To function, an organization requires people to take action in the form of approving something, agreeing to something, verifying something, affirming that something is acceptable, etc. The people who are expected to take such action can be prospects, clients, employees, citizens, partners, etc. In general, the process of acquiring indications that the desired action was taken (e.g., the thing was approved, agreed to, verified, affirmed, etc.) is repetitive and inefficient. The process of acquiring the indications tends to be a manual/human process. The manual/human nature of the process renders it vulnerable to problems, for example, the actions taken (e.g., agreeing to something) are not explicit, are poorly (or not) documented, are taken over a protracted time frame (e.g., due to mismanagement in the form of not diligently following up with reminders to people of whom action has been requested but who have not yet been performed the requested action), etc. Consequently, the organization wastes time, can become exposed to added business, regulatory, safety and legal risks, etc.

### SUMMARY

In one aspect of the present invention, there is provided a method of prosecuting acquisition of formal responses to a formal proposition put forth by a requestor, the method comprising: electronically sending the proposition to a group of recipients; automatically tracking responses to the proposition; automatically determining statistics indicative of the tracked responses including a completion ratio; and electronically presenting to the requestor at least some of the statistics including the completion ratio.

In another aspect, there is provided method of prosecuting generation of formal responses by a recipient to propositions put forth by one or more requestors, the method comprising: electronically sending at least first and second propositions to at least first and second groups of recipients; automatically tracking at least first and second sets of responses to the at least first and second propositions; and automatically determining at least first and second statistics indicative of the at least first and second sets of tracked responses; wherein there is a recipient who is common to the first and second groups; and wherein the method further comprises electronically presenting to the common recipient a summary regarding progress-statuses including indications of whether the common recipient has responded to the first and second propositions, respectively.

In yet another aspect, there is provided system of prosecuting acquisition of formal responses to a formal proposition put forth by a requestor, the system comprising: a processor; and a memory operatively coupled to the processor; wherein the processor is operable to do at least the following, electronically send the proposition to a group of recipients, automatically track responses to the proposition, automatically determine statistics indicative of the tracked responses including a completion ratio, and electronically present to the requestor at least some of the statistics including the completion ratio.

In yet another aspect, there is provided system of system of prosecuting generation of formal responses by a recipient to propositions put forth by one or more requestors, the system comprising: a processor; and a memory operatively coupled to the processor; wherein the processor is operable to do at least the following, electronically send at least first and second propositions to at least first and second groups of recipients, automatically track at least first and second sets of responses to the at least first and second propositions, and automatically determine at least first and second statistics indicative of the at least first and second sets of tracked responses; wherein there is a recipient who is common to the first and second groups; and wherein the processor is further operable to at least electronically present to the common recipient a summary regarding progress-statuses including indications of whether the common recipient has responded to the first and second propositions, respectively.

### BRIEF DESCRIPTION OF THE DRAWINGS

Illustrative embodiments of the present invention are described herein with reference to the accompanying drawings, in which:

FIG. 1 is a block diagram illustrating a system for prosecuting acquisition of formal responses to a formal proposition, according to an embodiment of the present invention;

FIG. 2 illustrates a layered architecture which can be used to implement the system of FIG. 1, according to an embodiment of the present invention;

FIG. 3A is a state diagram illustrating some of the states through which a requestor can navigate, according to an embodiment of the present invention;

FIG. 3B illustrates an example of dashboard tab, according to an embodiment of the present invention;

FIG. 3C illustrates an example of propositions overall tab, according to an embodiment of the present invention;

FIG. 3D illustrates an example of documents overall tab, according to an embodiment of the present invention;

FIG. 3E illustrates an example of people overall tab, according to an embodiment of the present invention;

FIG. 3F illustrates an example of account tab, according to an embodiment of the present invention;

FIG. 3G illustrates an example of propositions individual page, according to an embodiment of the present invention;

FIG. 3H illustrates an example of documents individual page, according to an embodiment of the present invention;.

FIG. 3I illustrates an example of people individual page, according to an embodiment of the present invention;.

FIG. 4A is a flowchart illustrating a method of prosecuting acquisition of formal responses to a formal proposition, according to an embodiment of the present invention;

FIG. 4B is a flowchart illustrating a method of configuring a proposition, according to an embodiment of the present invention;

FIG. 4C illustrates an example (according to an embodiment of the present invention) of a recipient selection dialog that can be presented to a requestor;

FIG. 4D illustrates an example (according to an embodiment of the present invention) of a document selection dialog that can be presented to requestor;

FIG. 4E illustrates an example (according to an embodiment of the present invention) of a scheduling dialog that can be presented to requestor; and

FIG. 4F illustrates an example (according to an embodiment of the present invention) of a proposition confirmation configuration dialog that can be presented to requestor.

### DETAILED DESCRIPTION

To function, every organization requires people to take action in the form of approving something, agreeing to something, verifying something, affirming that something is acceptable, etc. The people taking such action can be prospects, clients, employees, citizens, partners, etc. In general, the process of acquiring indications that the desired action was taken (e.g., the thing was approved, agreed to, verified, affirmed, etc.) is repetitive and inefficient. Too often, the actions taken (e.g., agreeing to something) are not explicit, poorly (or not) documented, or the process is otherwise mismanaged (e.g., by not diligently following up with reminders to people of whom action has been requested but such action has not yet been performed). Consequently, the organization wastes time, can become exposed to added business, regulatory, safety and legal risks, etc.

One or more embodiments of the present invention reduce, if not eliminate, the problems of the Related Art. Such embodiments automate and manage the repetitive and otherwise inefficient process of acquiring indications that the desired action was taken. Benefits of such embodiments include: improved outcomes, e.g., a doctor can confirm patient compliance to treatment regimes; reduced opportunity costs, e.g., instead of spending time chasing down employees to acknowledge receipt of a new employee manual, a member of a Human Resources (HR) staff can spend time examining benefits plans; improved alignment, e.g., training managers can confirm that employees are aware of and adhere to critical policies that protect the employees (and their employer); reduced paper-based file-storage needs, e.g., instead of loose paper in someone's filing cabinet, the subjects of the requested actions and the corresponding actions are stored in electronic format and are available for instant retrieval; reduced risk, e.g., people who take action tend to be more committed to action they take than to action taken by others, e.g., contractors who regularly reaffirm their status as contractors tend to be more reticent to suggest that they should be considered employees in order to gain additional benefits.

Managing the process of acquiring indications that a desired action was taken can be described more generally as prosecuting the acquisition of formal responses to a formal proposition put forth by a requestor. Here, the use of the term “prosecuting” is intended to connote following up with, or carrying forward, the acquisition so as to facilitate acquiring a complete set of responses. Such prosecution includes: electronically sending the proposition to a group of recipients; automatically tracking responses to the proposition; automatically determining statistics indicative of the tracked responses including a completion ratio; and electronically presenting to the requestor at least some of the statistics including the completion ratio.

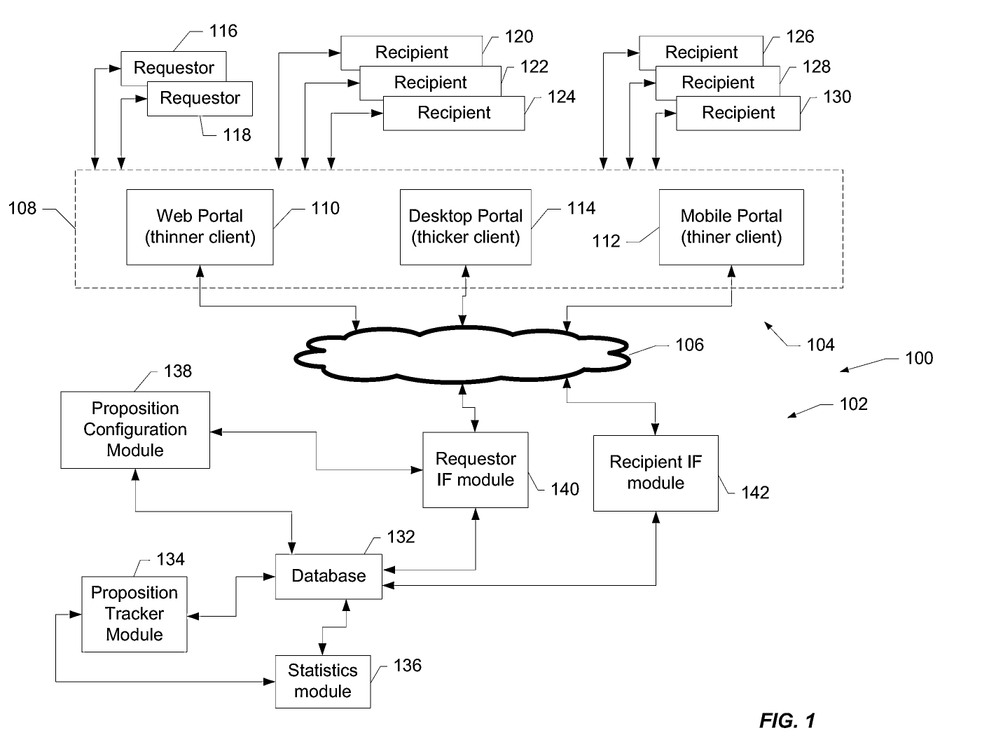

FIG. 1 is a block diagram illustrating a system 100 for prosecuting acquisition of formal responses to a formal proposition, according to an embodiment of the present invention.

In FIG. 1, the system 100 includes a software-as-a-service (SAAS) architecture 102 that communicates with a user-interface 104 through a network 106, e.g., the internet. User interface 108 can include a web portal 110, a mobile portal 112 and a desktop portal 112, where portals 110 and 112 can be relatively thinner types of clients and portal 112 can be a relatively thicker type of client. Requestors 116 and 118 and recipients 120-130 communicate, respectively, with system 102 via user interface 108. Multiple requestors can use system 102. For simplicity of illustration, only two requestors 116 and 118 have been illustrated, but more are contemplated. Likewise, multiple recipients can receive propositions via system 102. Again, for simplicity of illustration, only six recipients 120-130 are illustrated, but more are contemplated.

A requester, e.g., 116, is a user that is responsible for prosecuting the acquisition of formal responses to a formal proposition, and who uses system 102 to electronically send the proposition to a group of recipients, e.g., some or all of recipients 120-130, e.g., sending the proposition in the form of emails to the recipients. Furthermore, requestor 116 uses system 102 to automatically track responses to the proposition, and automatically determine statistics indicative of the tracked responses (including a completion ratio). Interface 108 electronically presents at least some of the statistics (including the completion ratio) to requestor 116.

System 102 can include a database 132 (e.g., a MySQL™ brand of relational database), a proposition tracker module 134, a statistics module 136, proposition configuration module 138, a requestor interface IF module 140 and a recipient IF module 142. Requestor IF module 140 and recipient IF module 142 are counterparts to and interact with user interface 108, respectively. Requestor IF module 140 and recipient IF module 142 also interact with database 132. Proposition configuration module 138 interacts with database 132 and requestor IF module 140. Proposition tracker module 134 interacts with statistics module 136 and database 132. And statistics module 136 interacts with database 132.

Among other data, a proposition is stored in database 132 and is configured to include a written definition of a subject of the proposition, and a written definition of an affirmation being sought as a desired response to the proposition. Typically, the proposition will also include a written definition of the solicitation being made to the recipient of the proposition. And example of a solicitation is, “Please read the attached proposition and the noted affirmation, and respond by clicking the “Make-Affirmation-Now” button.” As will be described in more detail below, configuration module 138 is used to configure a proposition.

Statistics module calculates statistics related to the propositions, e.g., progress-status statistics; see discussion below regarding statistics area 558 of FIG. 5B. Tracker module 134 tracks changes to the fields corresponding, e.g., to the affirmation fields for a proposition stored in database 132. Upon recognizing a change in an affirmation field, tracker module 134 can trigger statistics module 134 to updates its calculations accordingly.

When a proposition is sent to a group of recipients, each proposition includes a mechanism to make his affirmation, e.g., the Make-Affirmation-Now” button mentioned above. Using such a mechanism, a recipient (e.g., 120) causes a change to be made in database 132 to a corresponding field that represents whether recipient 120 has affirmed the proposition or not. For example, by clicking on the Make-Affirmation-Now button, recipient 120 communicates via interface 108 to recipient IF module 108, which changes the corresponding field in database 132. When any a change to database 132 is made, database 132 can be configured to push a change notice out to tracker module 134, which filters such change notices for affirmation-related change notices. If the change is affirmation-related, then tracker module 134 can trigger statistics module 132 to update its calculations accordingly.

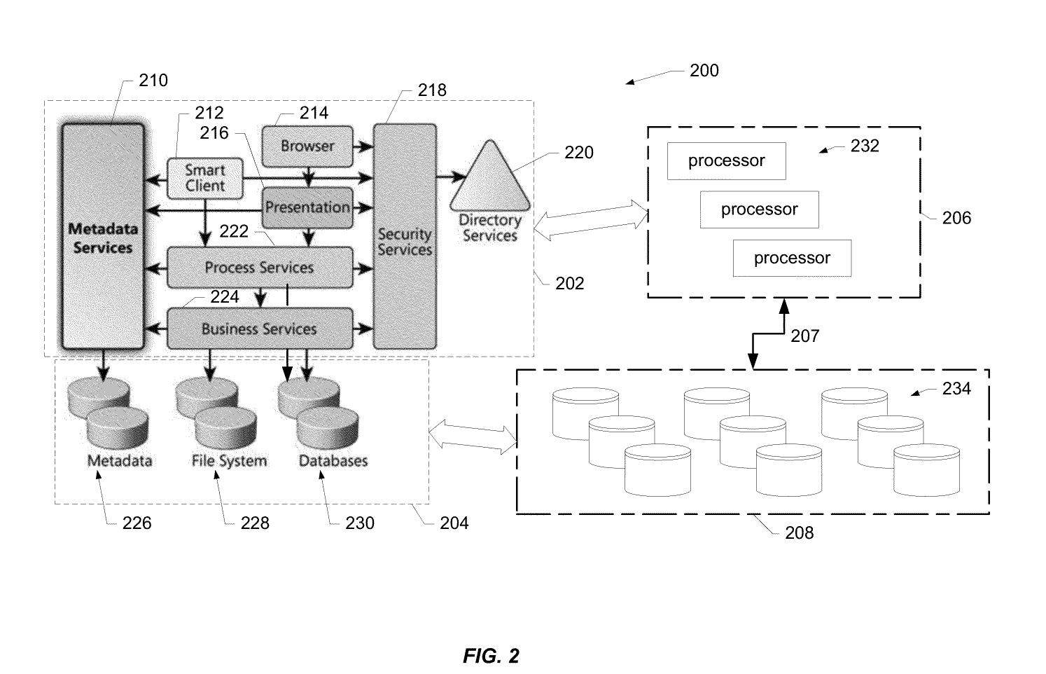

FIG. 2 illustrates a layered architecture 200 which can be used to implement system 100, according to an embodiment of the present invention.

Architecture 200 includes a services portion 202, a data portion 204, physical processing hardware 206 (including processors 232) and physical storage hardware 208 (including memory devices 234). One or more physical communications links 207 are provide between hardware 206 and hardware 208. Services portion 202 includes business services 224, process services 22, metadata services 210, security services 218, directory services 220, presentation services 216, smart client services 212 and browser services 214. Various communications paths amongst the services are illustrated. Data portion 204 includes one or more sets of metadata 226, one or more sets of file system data 228 and one or more sets of database data 230. Services portion 202 is provided by physical hardware 206. Data portion 204 is provided by physical storage hardware 208. Various communications paths between the services and the sets of data are illustrated. Other services per se, arrangements of services, data sets per se and arrangements of data sets are contemplated.

Examples of correspondences between FIG. 1 and FIG. 2 include the following. Mobile portal 112 can correspond to smart client services 212. Web portal 110 can correspond to browser services 110 and presentation services 216. Modules 138, 140 and 142 can correspond to process services 222, respectively. Modules 140 and 142 can also correspond to security services 218. Modules 134 and 136 can correspond to business services 224, respectively. Database 132 can correspond to one or more of the sets of database data 230.

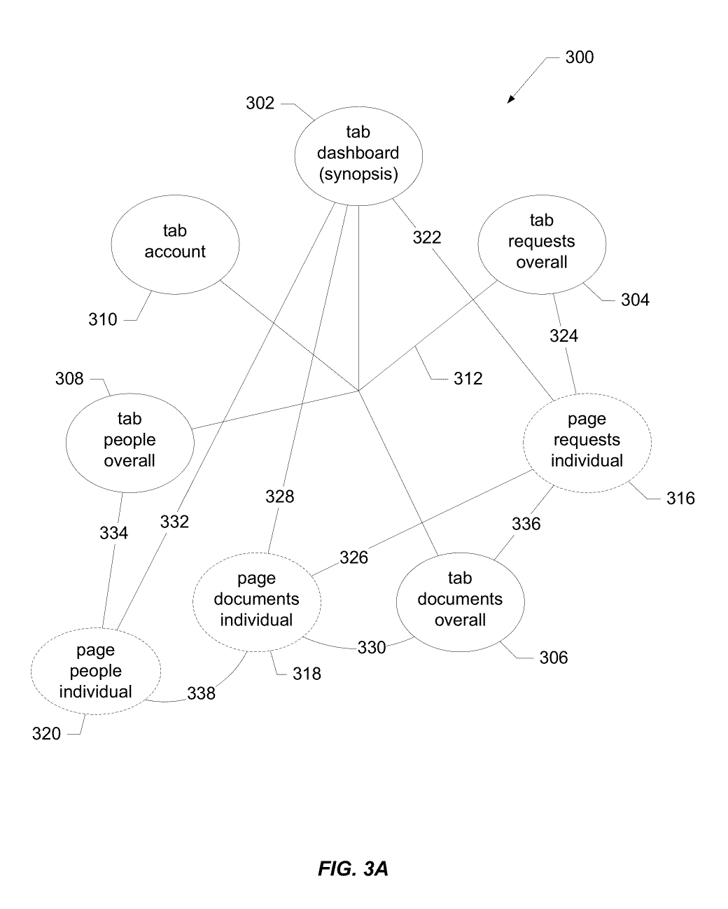

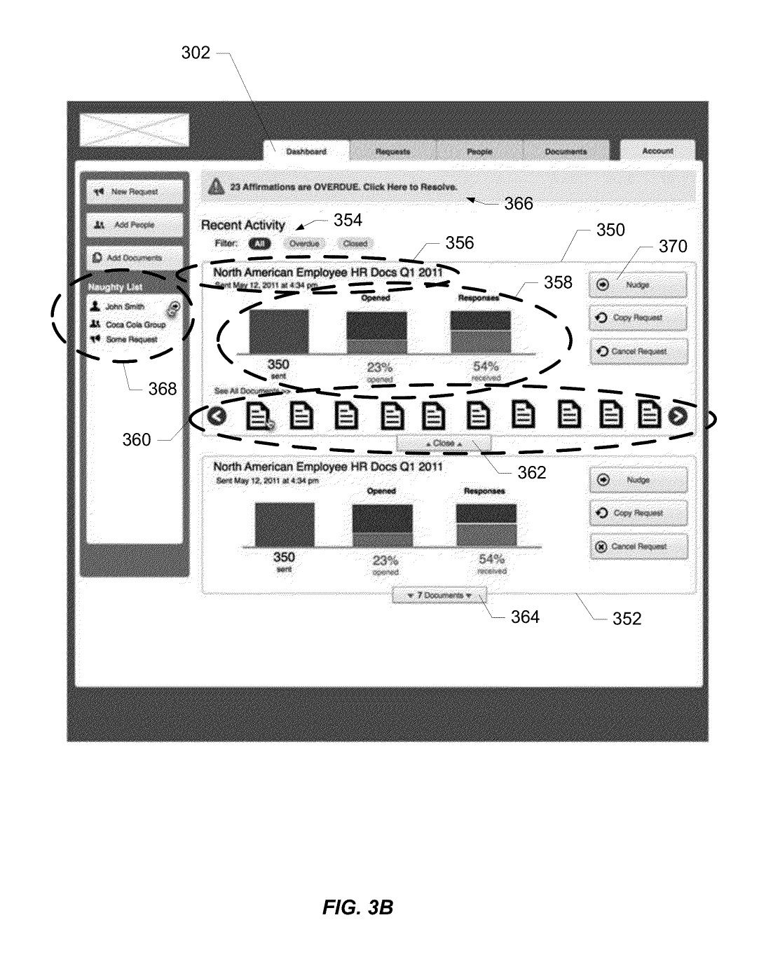

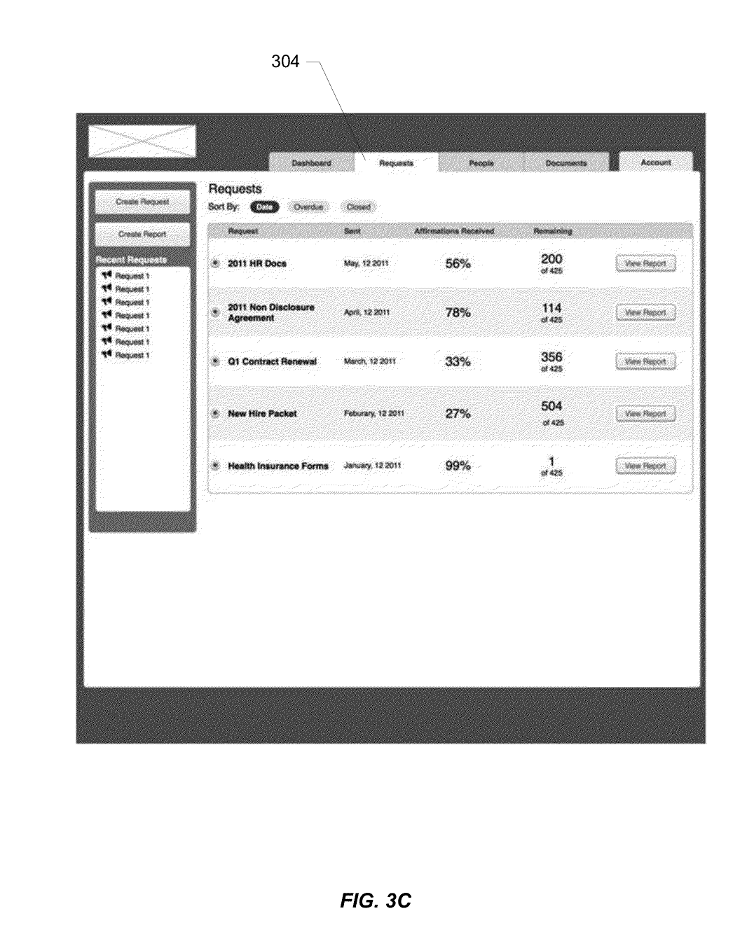

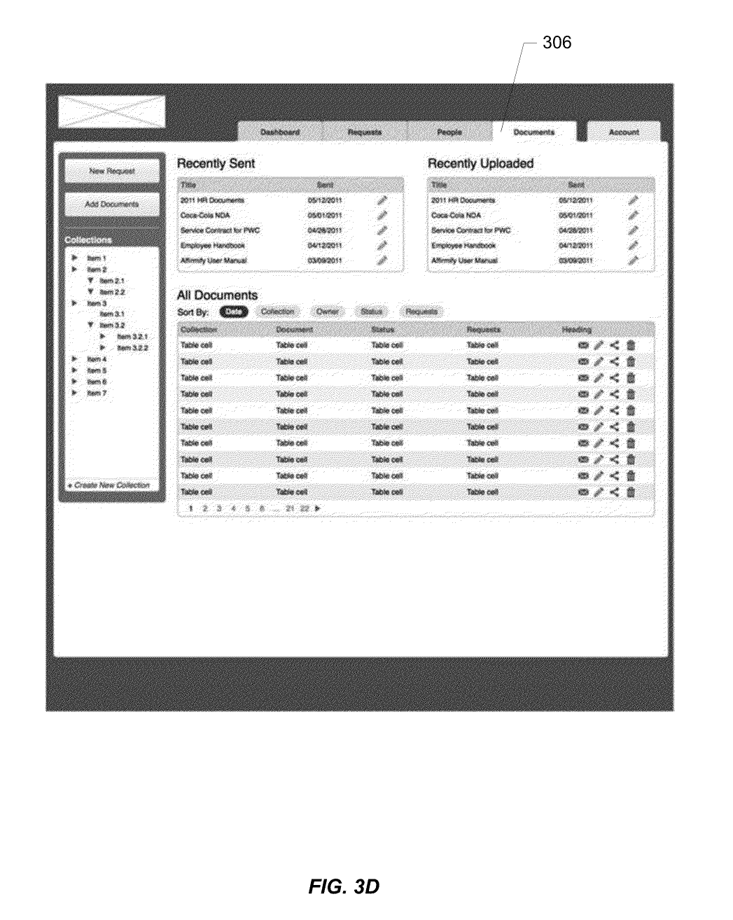

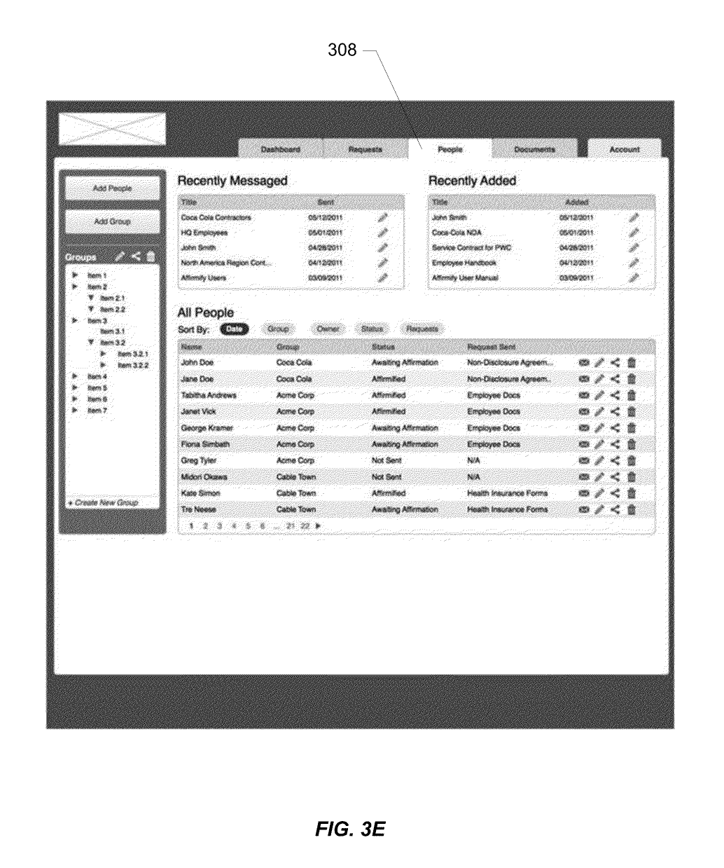

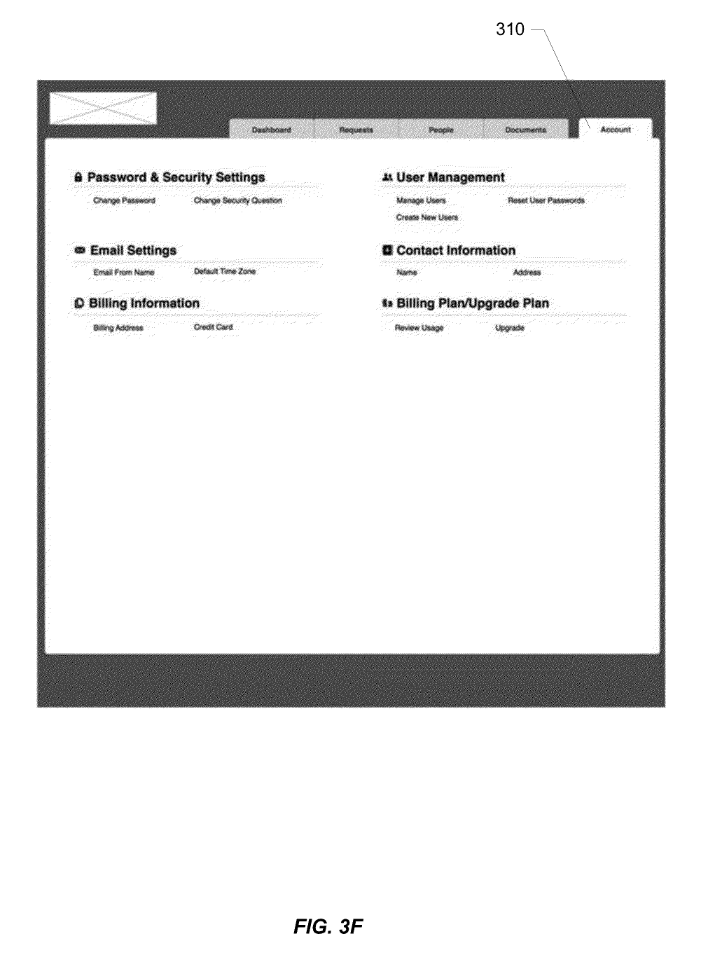

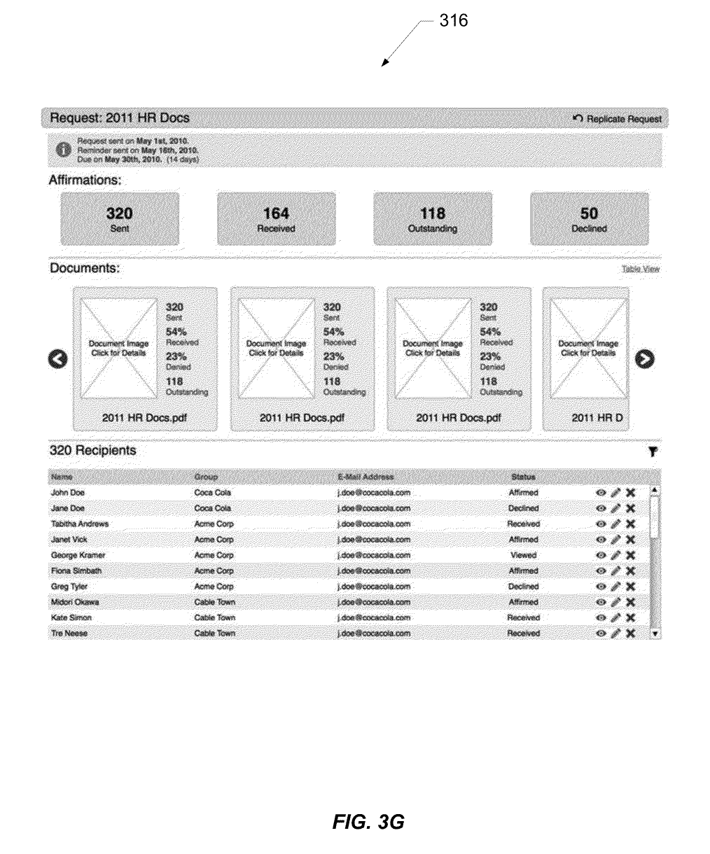

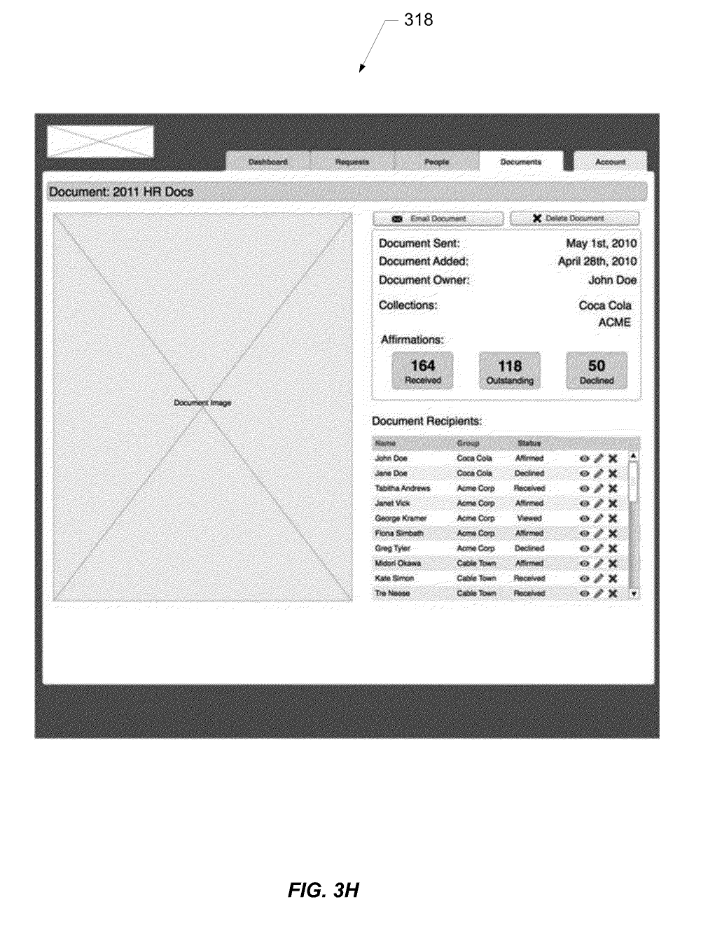

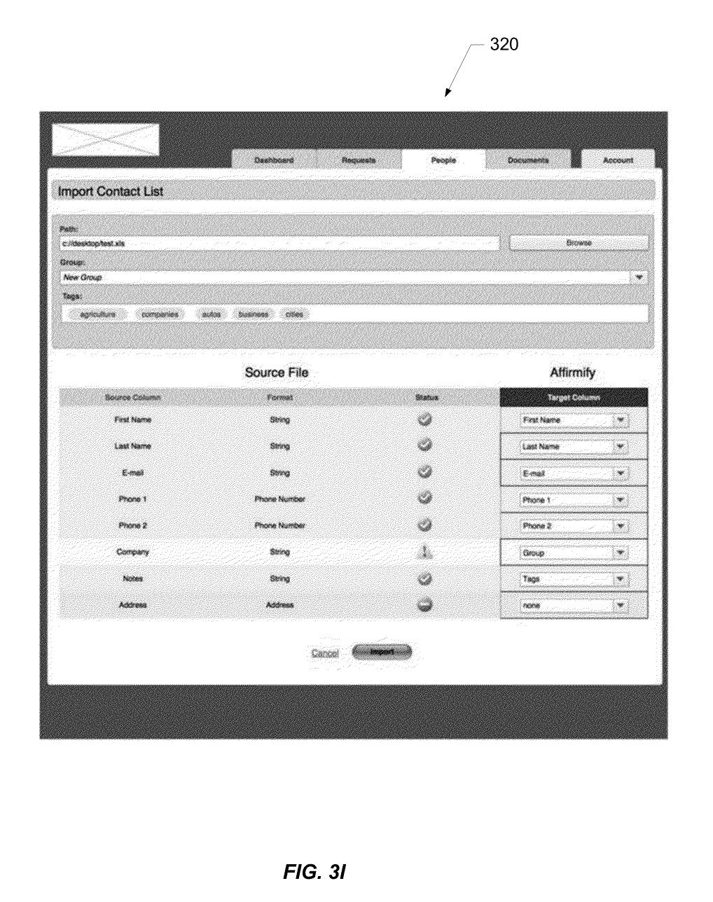

User interface 104, among other things, displays pages to a requestor, e.g., 116. Via embedded bidirectional links, requestor 116 can navigate through the display pages. FIG. 3A is a state diagram 300 illustrating some of the states (here display pages) through which requestor 116 can navigate, according to an embodiment of the present invention.

State diagram 300 includes states representing tabbed versions of a default page as well as deeper pages to which requestor 116 can drill down, plus direct links connecting various tabs and pages, respectively. More particularly, tabs of state diagram 300 include dashboard tab 302, propositions overall tab 304, documents overall tab 306, people overall tab 308 and account tab 310. For example, a requestor can navigate between any two of tabs 302-310 via a link 312. Deeper pages of state diagram 300 include propositions individual page 316, documents individual page 318 and people individual page 320. Pages 316-320 are described as deeper relative to tabs 302-308 to reflect that requestor 116 typically reaches one of pages 316-320 by having initially drilled down from one of tabs 304-308. Requestor 116 can navigate directly from tab 304 to pages 616, 318 and 320 via links 322, 328 and 332, respectively. Furthermore, requestor 116 can navigate: between tab 304 and page 316 via link 324; between tab 306 and pages 316 and 318 via links 336 and 330, respectively; between page 318 and pages 316 and 320 via links 326 and 338, respectively; and between tab 308 and page 320 via link 334.

FIG. 3B illustrates an example of dashboard tab 302, according to an embodiment of the present invention. Dashboard tab 302 can be described as a proposition-centric arrangement of information.

Dashboard tab 302 is configured to be a synopsis of progress-statuses regarding a requestor's (e.g., 116) propositions. For simplicity of illustration, only two propositions are assumed in FIG. 3B, corresponding to summary content areas 350 and 352, respectively; other numbers of propositions are contemplated for which he is prosecuting acquisitions of responses, respectively. Dashboard tab 302 includes additional content areas, for example: filter 354; bibliographic data 356; statistics area 358; documents list 360; headline 366; naughty list 368 and a nudge button 368.

Filter 354 can include buttons to selectively filter which progress-statuses are displayed, e.g., for all of the propositions, only overdue propositions, only closed propositions, etc. Statistics area 358 can include both numerical statistics and charts illustrating the statistics. For example, numerical statistics can include the number of propositions sent (which typically equals the number of recipients), the number of propositions which tracking info indicates have been opened and/or a ratio (e.g., a percentage) of the same, the number of affirmations received and/or a ratio (e.g., a percentage) of the same, etc. Document list 360 can include, e.g., document icons (that also can be links) representing the documents included in the proposition. Furthermore, document list 360 can be represented in an expanded format 362 or a collapsed format 364. Naughty list 368 can be configured, for example, as a subset of a list (not illustrated) of all recipients that are overdue in terms of submitting an affirmation, that is, all those who have yet to act upon propositions and for which the elapsed inaction intervals exceed desired values, respectively. Nudge button 370 can be configured to trigger an ad hoc reminder, e.g., of a predetermined configuration.

FIG. 3C illustrates an example of propositions overall tab 304, according to an embodiment of the present invention. Propositions overall tab 304 also can be described as a proposition-centric arrangement of information.

FIG. 3D illustrates an example of documents overall tab 306, according to an embodiment of the present invention. Documents overall tab 306 can be described as a document-centric arrangement of information.

FIG. 3E illustrates an example of people overall tab 308, according to an embodiment of the present invention. People overall tab 308 can be described as a recipient-centric arrangement of information.

FIG. 3F illustrates an example of account tab 310, according to an embodiment of the present invention.

FIG. 3G illustrates an example of propositions individual page 316, according to an embodiment of the present invention. Propositions individual page 316 also can be described as a proposition-centric arrangement of information.

FIG. 3H illustrates an example of documents individual page 318, according to an embodiment of the present invention. Documents individual page 318 also can be described as a document-centric arrangement of information.

FIG. 3I illustrates an example of people individual page 320, according to an embodiment of the present invention. People individual page 320 also can be described as a recipient-centric arrangement of information.

FIGS. 3B-3I can be described as requestor-perspective arrangements of information. System 100 can also generate corresponding pages that can be described are recipient-perspective arrangements of information. A requestor, e.g., 120, can interact with user interface 108, and thus indirectly with recipient IF module 142, which can provide user 120 with pages that inform user 120 regarding propositions for he is amongst the recipients. Information communicated via such recipient-perspective pages can include a summary of progress-statuses for the propositions he has received, including indications of whether the recipient has responded to the propositions, respectively. Such recipient pages further can include qualitative indications of intervals elapsed since the propositions were received, respectively, and/or quantitative indications of intervals elapsed since the propositions were received, respectively.

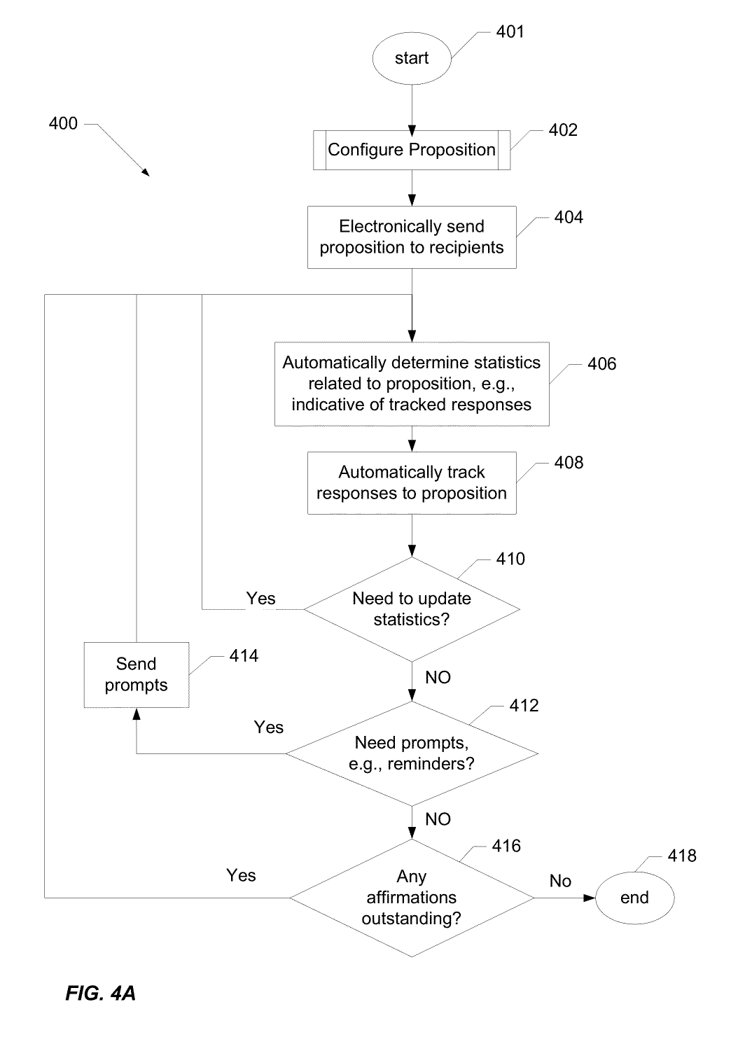

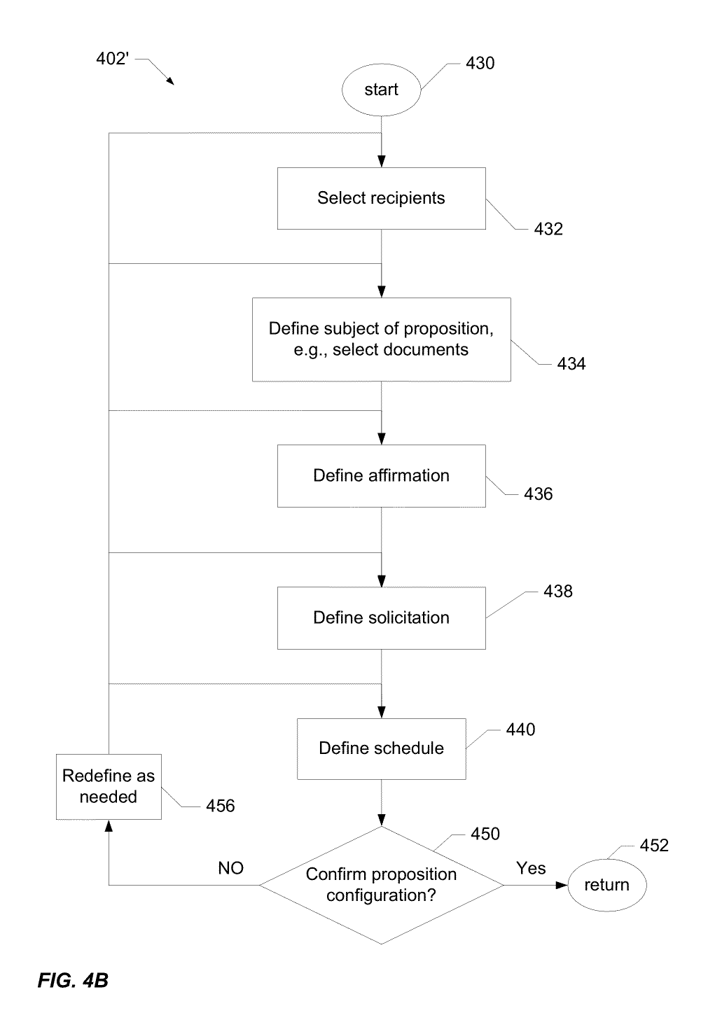

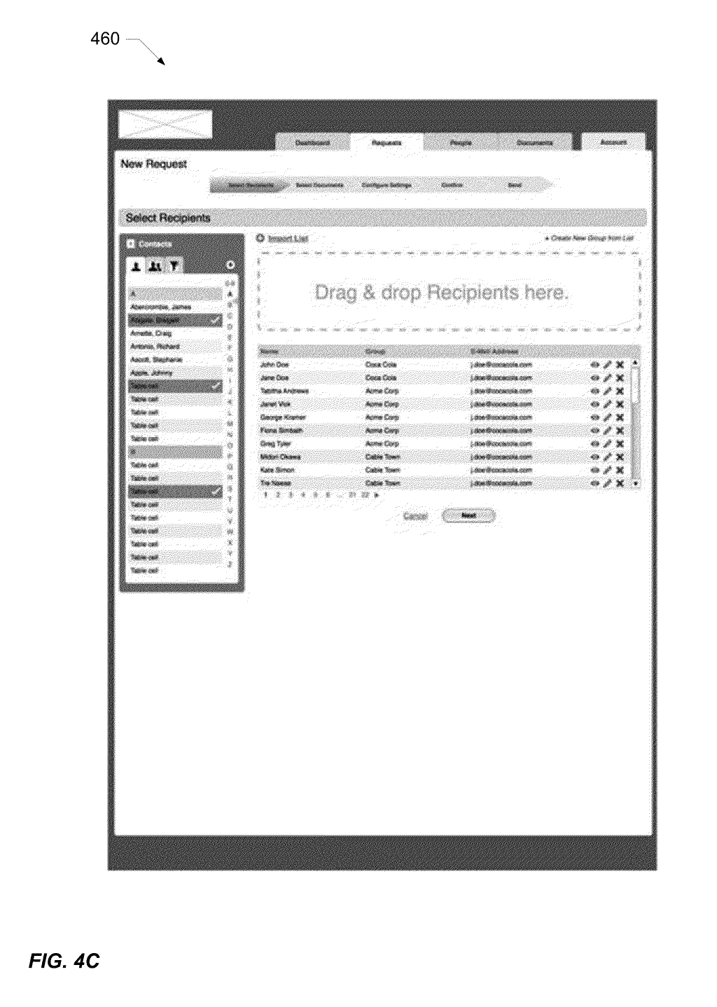

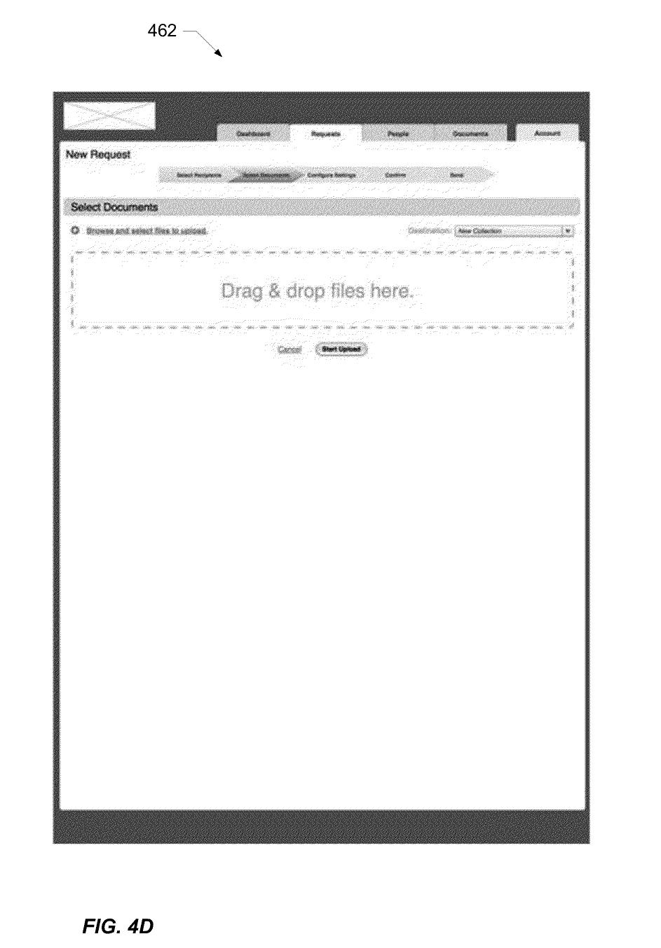

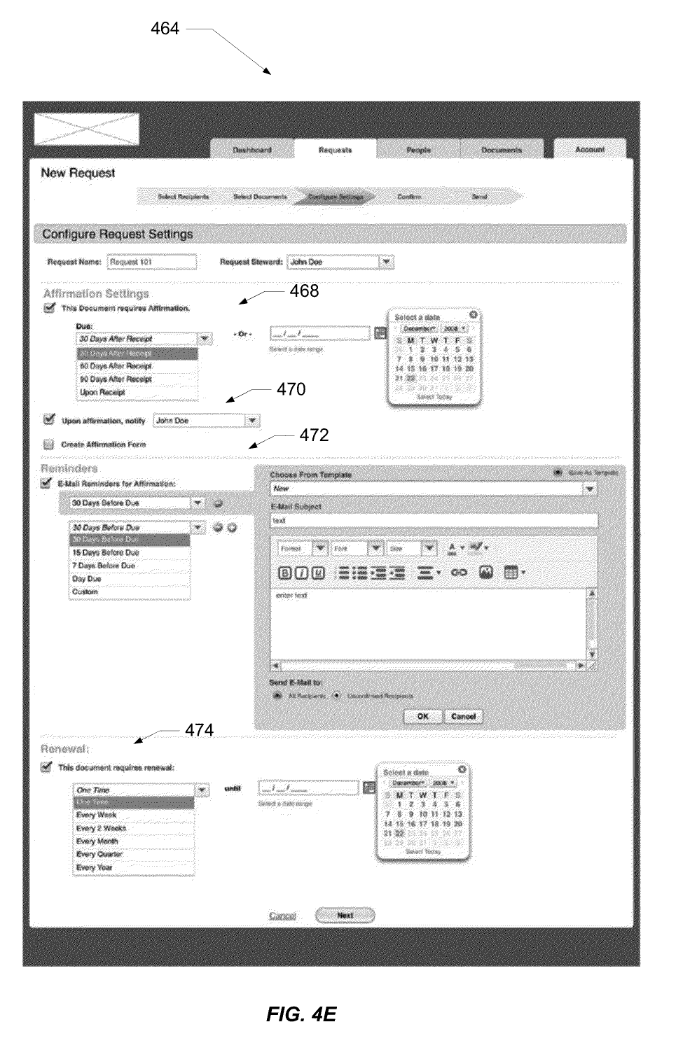

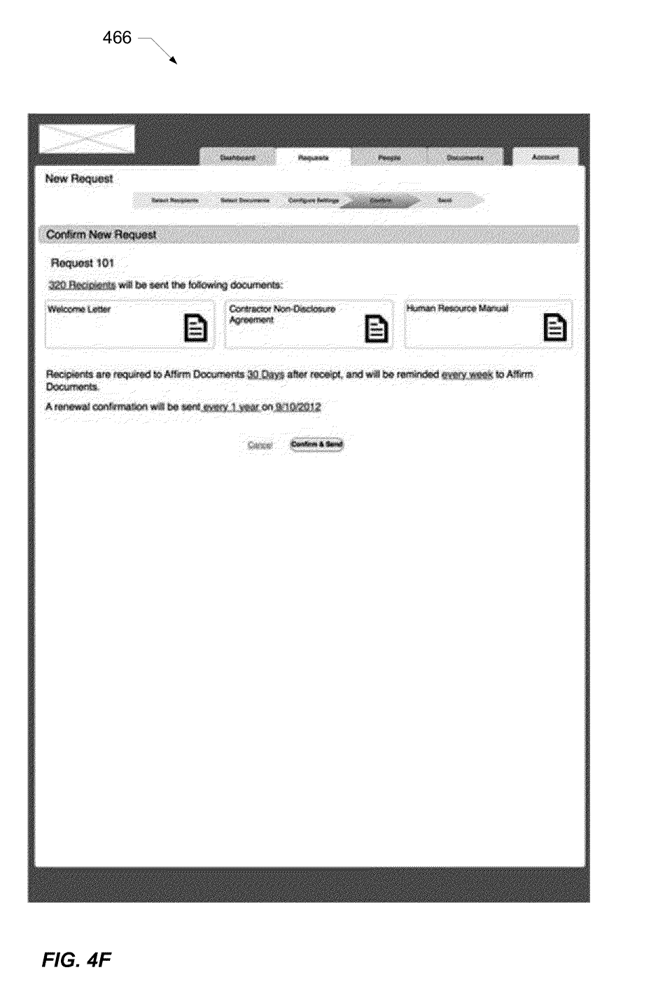

FIG. 4A is a flowchart illustrating a method 400 of prosecuting acquisition of formal responses to a formal proposition, according to an embodiment of the present invention.

In the flowchart of FIG. 4A, flow starts at a block 401 and proceeds to a block 402, where a proposition is configured. Details of block 402 are discussed below relative to FIG. 4B. From block 402, flow proceeds to block 404 where the proposition is sent electronically, e.g., as emails, to a group of recipients. From proceeds from block 404 to a block 406, where statistics regarding the proposition are automatically determined. For example, statistics indicative of the tracked responses are determined. From block 406, flow proceeds to block 408, where responses to the proposition are tracked. From proceeds from block 408 to block 410, where it is decided whether there is a need to update the statistics. For example, if block 408 determines that an affirmation has been received, then the decision at block 410 will be yes, and flow will loop back to block 406. But if block 410 determines that there is no need to update the statistics, then flow proceeds to a block to 412, where it is decided whether prompts, e.g., reminders need to be sent. If so, then flow proceeds to a block 414, where such prompts are sent. From block 414, flow loops back to block 406. If block 412 determines that there is no need to send prompts, then flow proceeds to a block 416, where it is determined whether there are any affirmations that remain outstanding, i.e., that have yet to have been received. If so, then flow loops back to block 406. But if block 416 determines that no affirmations remain outstanding, then flow proceeds to a block 418 and ends.

FIG. 4B is a flowchart illustrating a method 402′ of configuring a proposition, according to an embodiment of the present invention. Details of block 402 in FIG. 4A are illustrated as method 402′ of FIG. 4B. Stated differently, flow jumps from within block 402 to method 402′.

In the flowchart of FIG. 4B, flow starts at a block 430 and proceeds to a block 432, where recipients of the proposition are selected. FIG. 4C illustrates an example (according to an embodiment of the present invention) of a recipient selection dialog 460 that can be presented to a requestor, e.g., requestor 116. As part of carrying out block 434, requestor 116 can be presented with a characteristics-selection dialog in addition to, or as an alternative to, recipient selection dialog 460. The characteristics-selections dialog is used by requestor 116 to select characteristics, e.g., demographic characteristics, that determine of which of a set of recipients will be automatically selected.

Flow proceeds from block 432 in FIG. 4B to a block 434, where a subject of the proposition is defined. For example, the subject can be defined by selecting as attachment one or more documents, one or several of which contains a formal, written definition of the subject. FIG. 4D illustrates an example (according to an embodiment of the present invention) of a document selection dialog 462 that can be presented to requestor 116 as part of carrying out block 434. Alternatively, as part of carrying out block 434, requestor 116 can be presented with a dialog in which requestor 116 can type a definition of the subject.

Flow proceeds from block 434 in FIG. 4B to a block 436, where an affirmation of the proposition is defined. For example, the affirmation can be defined by selecting as attachment one or more documents, one or several of which contains a formal, written definition of the affirmation. As with block 434, document selection dialog 462 also can be presented to requestor 116 as part of carrying our block 436. Alternatively, as part of carrying out block 436, requestor 116 can be presented with a dialog in which requestor 116 can type a definition of the affirmation. Flow proceeds from block 436 to a block 438, where a solicitation is defined. For example, as part of carrying out block 438, requestor 116 can be presented with a dialog in which requestor 116 can type a definition of the solicitation and/or can choose from one or more predetermined solicitation definitions.

Flow proceeds from block 438 to a block 440, where a schedule for prosecuting the proposition is defined. FIG. 4E illustrates an example (according to an embodiment of the present invention) of a scheduling dialog 464 that can be presented to requestor 116 as part of carrying out block 440. Dialog 464 has interaction areas, some of which include: due date interaction area 468 where a due date for receipt of all affirmations can be set; completion notification interaction area 470; reminder interaction area 472; and renewal interaction area 474.

Reminder interaction area 472, for example, can set one or more prompts, e.g., reminder emails, that include the same content or different content. If different content is selected, the differing content can be configured to communicate an escalating sense of urgency from one prompt relative to the next subsequent prompt.

From block 440, flow proceeds to a block 450, where requestor 116 is, in effect, asked to confirm the configuration of the proposition. If requestor 116 answers yes, i.e., does confirm the configuration, then flow proceeds to a block 452 and returns to block 402 in FIG. 4A. FIG. 4F illustrates an example (according to an embodiment of the present invention) of a proposition confirmation configuration dialog 466 that can be presented to requestor 116 as part of carrying out block 450.

Examples of circumstances to which one or more embodiments of the present can be applied include: U.S. Internal Revenue Service form W-9 (independent contractor) collection; health/medical insurance verification (terms/conditions for coverage or preferred rates); investor qualifications verification; investor risk tolerance renewal; non-disclosure agreements collection; conflict of interest statements collection; security guard qualifications verification; doctor-patient communications verification; annual professional certification collection; contractor status confirmation; chemical/material safety confirmation; workplace safety training confirmation; patient treatment/medication confirmation; work-order change confirmation; residency verification; etc.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

Reference herein to “one embodiment” or “an embodiment” means that a particular feature, structure, operation, or other characteristic described in connection with the embodiment may be included in at least one implementation of the present invention. However, the appearance of the phrase “in one embodiment” or “in an embodiment” in various places in the specification does not necessarily refer to the same embodiment. It is further envisioned that a skilled person could use any or all of the above embodiments in any compatible combination or permutation.

While various embodiments of the present invention have been described above, it should be understood that they have been presented by way of example only, and not limitation. It will be apparent to persons skilled in the relevant art that various changes in form and detail may be made therein without departing from the scope of the invention. Thus, the breadth and scope of the present invention should not be limited by any of the above-described exemplary embodiments, but should be defined only in accordance with the following claims and their equivalents.

What is claimed is:

1. A method of prosecuting acquisition of formal responses to a formal proposition put forth by a requestor, the method comprising:
electronically sending the proposition to a group of recipients;
automatically tracking responses to the proposition;
automatically determining statistics indicative of the tracked responses including a completion ratio; and
electronically presenting to the requestor at least some of the statistics including the completion ratio.

2. The method of claim 1, wherein:
the statistics include a count of responses received; and
the completion ratio is based upon the count and a total number of sent requests.

3. The method of claim 2, wherein the ratio is presented as a percentage.

4. The method of claim 1, wherein the step of electronically presenting includes:
displaying a chart representing the ratio.

5. The method of claim 4, wherein the chart is a bar graph.

6. The method of claim 1, further comprising:
configuring an electronic representation of the proposition to include,
a written definition of a subject of the proposition, and
a written definition of an affirmation being sought as a desired response to the proposition.

7. The method of claim 6, wherein a configuration of the electronic representation of the proposition further includes:
a solicitation that a response be made in a form of an electronic communication of the affirmation to the requestor.

8. The method of claim 1, further comprising:
automatically sending, to those amongst the recipients for which a response has not been received, respectively, electronic prompts notifying that a response is awaited.

9. The method of claim 8, further comprising:
establishing a schedule for prosecuting the acquisition including, setting one or more reminder dates
wherein the electronic prompts are sent on the one or more reminder dates.

10. The method of claim 9, wherein:
there are at least first and second reminder dates and at least first and second corresponding prompts, respectively; and
the step of establishing the schedule further includes,
drafting different messages to be communicated by the at least first and second prompts, respectively.

11. The method of claim 10, wherein:
the second prompt is drafted so as to communicate an escalating sense of urgency relative to the first prompt.

12. The method of claim 8, wherein:
the prompts includes at least one of a qualitative and a quantitative indication of an interval elapsed since the proposition was sent.

13. The method of claim 1, wherein:
at least first and second propositions are sent electronically to at least first and second groups of recipients, respectively,
at least first and second sets of responses to the at least first and second propositions are automatically tracked, respectively;
at least first and second sets of statistics are automatically determined for the at least first and second sets of responses, respectively; and
the method further comprises,
displaying a synopsis of progress-statuses regarding at least first and second acquisitions of responses to at least the least first and second propositions, respectively.

14. The method of claim 13, wherein:
there is a recipient who is common to the first and second groups; and
the method further comprises,
displaying a summary regarding progress-statuses for the common recipient including indications of whether the common recipient has responded to the first and second propositions, respectively.

15. The method of claim 14, wherein the summary includes at least one of:
dates, if available, on which the responses were received, respectively;
qualitative indications of intervals elapsed since the propositions were sent, respectively;
quantitative indications of intervals elapsed since the propositions were sent, respectively.

16. The method of claim 13, wherein the statistics includes
a summary of overdue responses;
a summary of recipients for which there is a problem with delivery of the propositions, respectively;
a summary of a subset of higher-priority propositions; and
a summary of a subset of most delinquent recipients.

17. The method of claim 1, wherein the statistics includes
a summary of overdue responses;
a summary of recipients for which there is a problem with delivery of the propositions, respectively; and
a summary of a subset of most delinquent recipients.

18. The method of claim 1, wherein:
the method is implemented as software as a service (Saas).

19. A method of prosecuting generation of formal responses by a recipient to propositions put forth by one or more requestors, the method comprising:
electronically sending at least first and second propositions to at least first and second groups of recipients;
automatically tracking at least first and second sets of responses to the at least first and second propositions; and
automatically determining at least first and second statistics indicative of the at least first and second sets of tracked responses;
wherein there is a recipient who is common to the first and second groups; and
wherein the method further comprises,
electronically presenting to the common recipient a summary regarding progress-statuses including indications of whether the common recipient has responded to the first and second propositions, respectively.

20. The method of claim 19, wherein the summary includes at least one of:
dates, if available, on which the responses were sent, respectively;
qualitative indications of intervals elapsed since the propositions were received, respectively;
quantitative indications of intervals elapsed since the propositions were received, respectively.

21. The method of claim 20, wherein:
the method is implemented as software as a service (SaaS).

22. A system of prosecuting acquisition of formal responses to a formal proposition put forth by a requestor, the system comprising:
a processor; and
a memory operatively coupled to the processor;
wherein the processor is operable to do at least the following,
electronically send the proposition to a group of recipients,
automatically track responses to the proposition,
automatically determine statistics indicative of the tracked responses including a completion ratio, and
electronically present to the requestor at least some of the statistics including the completion ratio.

23. The system of claim 22, wherein:
the statistics include a count of responses received; and
the completion ratio is based upon the count and a total number of sent requests.

24. The system of claim 23, wherein the ratio is presented as a percentage.

25. The system of claim 22, wherein electronically presenting by the processor includes:
displaying a chart representing the ratio.

26. The system of claim 25, wherein the chart is a bar graph.

27. The system of claim 22, wherein the processor is further operable to:
configure an electronic representation of the proposition to include,
a written definition of a subject of the proposition, and
a written definition of an affirmation being sought as a desired response to the proposition.

28. The system of claim 27, wherein a configuration of the electronic representation of the proposition further includes:
a solicitation that a response be made in a form of an electronic communication of the affirmation to the requestor.

29. The system of claim 22 wherein the processor is further operable to:
automatically send, to those amongst the recipients for which a response has not been received, respectively, electronic prompts notifying that a response is awaited.

30. The system of claim 29, wherein the processor is further operable to:
establish a schedule for prosecuting the acquisition including,
setting one or more reminder dates
wherein the electronic prompts are sent on the one or more reminder dates.

31. The system of claim 30, wherein:
there are at least first and second reminder dates and at least first and second corresponding prompts, respectively; and
the processor is further operable to,
draft different messages to be communicated by the at least first and second prompts, respectively.

32. The system of claim 31, wherein:
the second prompt is drafted so as to communicate an escalating sense of urgency relative to the first prompt.

33. The system of claim 29, wherein:
the prompts includes at least one of a qualitative and a quantitative indication of an interval elapsed since the proposition was sent.

34. The system of claim 22, wherein:
at least first and second propositions are sent electronically to at least first and second groups of recipients, respectively,
at least first and second sets of responses to the at least first and second propositions are automatically tracked, respectively;
at least first and second sets of statistics are automatically determined for the at least first and second sets of responses, respectively; and
the processor is further operable to,
display a synopsis of progress-statuses regarding at least first and second acquisitions of responses to at least the least first and second propositions, respectively.

35. The system of claim 34, wherein:
there is a recipient who is common to the first and second groups; and
the processor is further operable to,
display a summary regarding progress-statuses for the common recipient including indications of whether the common recipient has responded to the first and second propositions, respectively.

36. The system of claim 35, wherein the summary includes at least one of:
dates, if available, on which the responses were received, respectively;
qualitative indications of intervals elapsed since the propositions were sent, respectively;
quantitative indications of intervals elapsed since the propositions were sent, respectively.

37. The system of claim 34, wherein the statistics includes
a summary of overdue responses;
a summary of recipients for which there is a problem with delivery of the propositions, respectively;
a summary of a subset of higher-priority propositions; and
a summary of a subset of most delinquent recipients.

38. The system of claim 22, wherein the statistics includes
a summary of overdue responses;
a summary of recipients for which there is a problem with delivery of the propositions, respectively; and
a summary of a subset of most delinquent recipients.

39. The system of claim 22, wherein:
the processor is operable in a context of a software as a service (SaaS) architecture.

40. A system of prosecuting generation of formal responses by a recipient to propositions put forth by one or more requestors, the system comprising:
a processor; and
a memory operatively coupled to the processor;
wherein the processor is operable to do at least the following,
electronically send at least first and second propositions to at least first and second groups of recipients,
automatically track at least first and second sets of responses to the at least first and second propositions, and
automatically determine at least first and second statistics indicative of the at least first and second sets of tracked responses;
wherein there is a recipient who is common to the first and second groups; and
wherein the processor is further operable to do at least the following,
electronically present to the common recipient a summary regarding progress-statuses including indications of whether the common recipient has responded to the first and second propositions, respectively.

41. The system of claim 40, wherein the summary includes at least one of:
dates, if available, on which the responses were sent, respectively;
qualitative indications of intervals elapsed since the propositions were received, respectively;
quantitative indications of intervals elapsed since the propositions were received, respectively.

42. The system of claim 41, wherein:
the processor is operable in a context of a software as a service (SaaS) architecture.
